(19) United States
(12) Patent Application Publication
(10) Pub. No.: US 2014/0136668 A1
(43) Pub. Date: May 15, 2014

(54) REAL-TIME SELF-OPTIMIZING SYSTEM FOR MULTITENANT BASED CLOUD INFRASTRUCTURE

(71) Applicants: FRANK BRUNSWIG, Heidelberg (DE); FRANK JENTSCH, Muehlhausen (DE); BARE SAID, St. Leon - Rot (DE)

(72) Inventors: FRANK BRUNSWIG, Heidelberg (DE); FRANK JENTSCH, Muehlhausen (DE); BARE SAID, St. Leon - Rot (DE)

(21) Appl. No.: 13/677,325

(22) Filed: Nov. 15, 2012

(51) Int. Cl. G06F 15/177

(52) U.S. Cl. 709/222

(57) ABSTRACT

A self-optimizing business software system, based on a multi-tenant database, is aware of the technical configuration of the system. Based on configurable key performance indicators, an optimizer is controlling, diversifying, and observing the system configuration and system execution to find the optimal technical configuration by using simulation streams, which run parallel to the production streams.

### FIELD

The field relates to optimizations of software systems. More precisely, the field relates to real-time self-optimizing system for multitenant based cloud infrastructure.

### BACKGROUND

One architecture pattern for large software systems consists of a persistency layer, an application layer, and a client layer. Typically, the persistence layer consists of a large database server, the application layer consists of many application servers, and the client layer handles at least thousands of users connected with client software such as, for example, an internet browser.

Today's challenge in the operation of such large software systems is to minimize the corresponding operational costs and to optimize the system to fulfill the expectations of the users regarding performance, reliability, security, and more. Most of the current approaches are based on the experience of the operators and the best practices which have been developed over a long period of time. The optimization and operation of those large software systems is a tedious trial.

Typically, large software systems consist of a persistency layer, an application layer, and a client layer which leads to different hardware requirements including different kind of configurations. The kinds of configuration have a huge variation from real physical hardware resources, operating system resource, up to more logical business application resources. Physical hardware resources are related to the used machine equipment like bus, memory, number and speed of central processor units (CPUs), network, hard disks, printers, etc. Operating system resources are related to virtual memory, caches, queues, semaphores, files, threads, processes, services, etc. Business application resources are related to business objects, agents, business tasks, mass data run objects, reports, etc.

For each machine responsible for the software execution on a specific layer an optimal list of all needed configuration parameters exists in a profile. In reality this profile is spread over many locations on a dedicated machine. Physical hardware parameters may be configured in the basic input/output system (BIOS) in case of a personal computer and the operating system resources may be configured in the Registry for example in case of the Microsoft Windows operating system. In addition, the business application resources may be configured in the business application system. Many of these parameters in the profile have dependencies between each other and cannot be configured without any constraints. For example, the maximum size of virtual memory depends on the available physical memory and the available disk space. In addition, the maximum table space size of a database also depends on the available disk space as well as the table caches depends on the available size of physical memory. Due to the large number of configuration parameters and their constraints, the optimization of a large software system is a challenge.

### SUMMARY

Various embodiments of systems and methods for real-time self-optimization of a business software system on multitenant based cloud infrastructure are described herein. In one embodiment, the method includes receiving an initial configuration of one or more application servers of a productive stream of the multitenant based cloud infrastructure, the productive stream operating on a tenant-enabled database, and wherein the initial configuration is within a freespace configuration defining ranges of configuration parameters based on key performance indicators (KPIs) for the performance of the business software system. The method further includes creating a simulation stream to operate parallel to the productive stream for configuration optimization purposes, the simulation stream comprising a tenant clone of the tenant-enabled database and a set of application servers reserved for simulations arid setting a simulation configuration by varying configuration parameters within the defined ranges of configuration parameters for the set of application servers reserved for simulation. The method further includes receiving one or more user requests to the tenant-enabled database through the productive stream, the one or more user requests processed by the one or more application servers of the productive stream and dispatching the received one or more user requests to the tenant clone of the tenant-enabled database through the simulation stream, the one or more user requests processed by the set of application servers reserved for simulations. The method further includes monitoring performance of the productive stream and the simulation stream for a predefined period and amount of processed user requests and applying the simulation configuration to the productive stream based on a comparison of KPIs of the simulation stream and KPIs of the productive stream.

In some embodiments, the system includes a tenant-enabled database and one or more application servers operating on the tenant-enabled database, the tenant enabled database and the one or more application servers forming a productive stream. The system also includes a tenant clone of the tenant-enabled database and a set of simulation application servers reserved for simulations, the simulation application servers operating on the tenant clone of the tenant-enabled database, the tenant clone and the set of simulation application servers forming a simulation stream. The system further includes a load balancer to handle client requests to the one or more application servers operating on the tenant-enabled database and to dispatch the client requests to the tenant clone of the tenant-enabled database through the set of simulation application servers. The system also includes an optimizer to set a simulation configuration by varying configuration parameters within defined ranges of configuration parameters for the set of simulation application servers, monitor performance of the tenant-enabled database with the one or more application servers and the tenant clone of the tenant-enabled database with the set of simulation application servers for predefined period and amount of processed client requests, and apply the simulation configuration to the productive stream based on a comparison of key performance indicators (KPIs) of the simulation stream and KPIs of the productive stream.

These and other benefits and features of embodiments will be apparent upon consideration of the following detailed description of preferred embodiments thereof, presented in connection with the following drawings.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a block diagram of an embodiment of a three-layer system architecture of multitenant based cloud infrastructure.

FIG. 2 is a flow diagram of an embodiment of a method of real-time self-optimization of a business software system on multitenant based cloud infrastructure.

FIG. 3 is a block diagram of an embodiment of a real-time self-optimizing business software system on multitenant based cloud infrastructure.

FIG. 4 is a block diagram illustrating a computing environment in which the techniques described for real-time self-optimization of a business software system on multitenant based cloud infrastructure can be implemented, according to an embodiment.

### DETAILED DESCRIPTION

Embodiments of techniques for real-time self-optimizing system for multitenant based cloud infrastructure are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

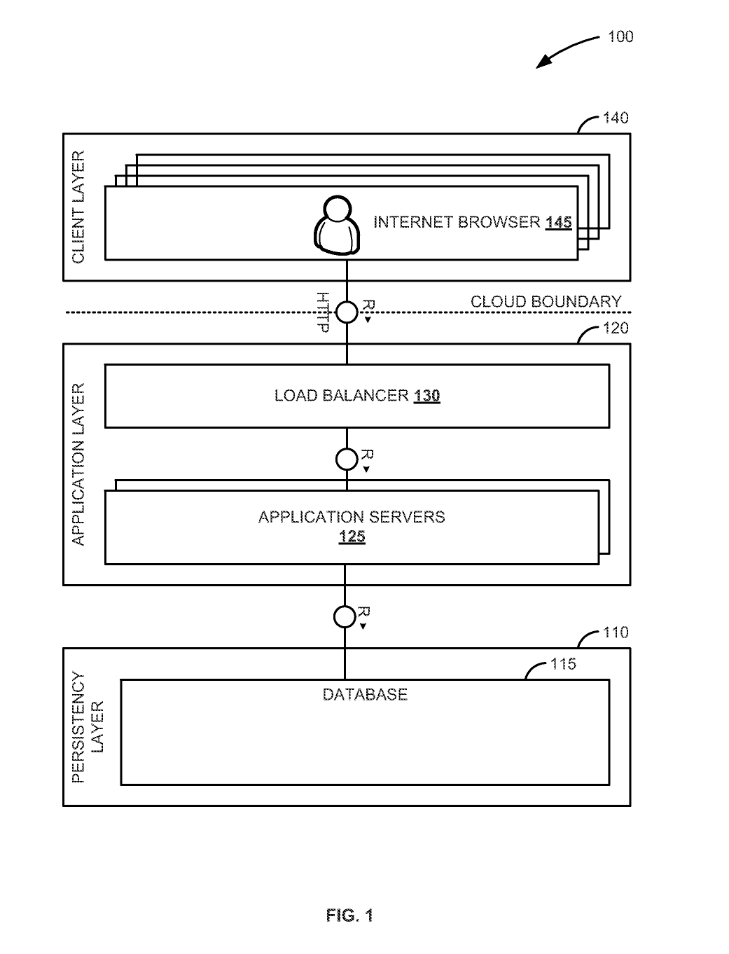

FIG. 1 is a block diagram of an embodiment of a three-layer system architecture for multitenant based cloud infrastructure. A system 100 includes a persistency layer 110, an application layer 120 and a client layer 140. The persistency layer 110 includes a database server 115. The database server 115 is tenant-enabled, which means that a single instance of software running the database server 115 is able to serve multiple client organizations (tenants). The application layer 120 includes application servers 125 and a load balancer 130. The load balancer 130 transmits incoming requests from the client layer 140 to available servers of the application servers 125. The load balancer 130 is operable to assign incoming requests to a set of application servers that are allocated to process such requests. The number of allocated application servers is dynamic and this is a factor applicable to optimization. The application servers 125 have their Own characteristics, which affect the response time to the requests. The response time is another factor for optimization. If there are no available servers, the client requests are queued. In one embodiment, the queued client requests are served according to the FIFO (First-In-First-Out) approach. The number of served requests is also a factor for optimization. The client layer 140 includes all users of the system 100 that are called clients or tenants as well. The number of served users is another factor applicable to configuration. The users of the system 100 send requests to the application servers 125 and the application servers operate on a same database within the database server 115 serving the different tenants.

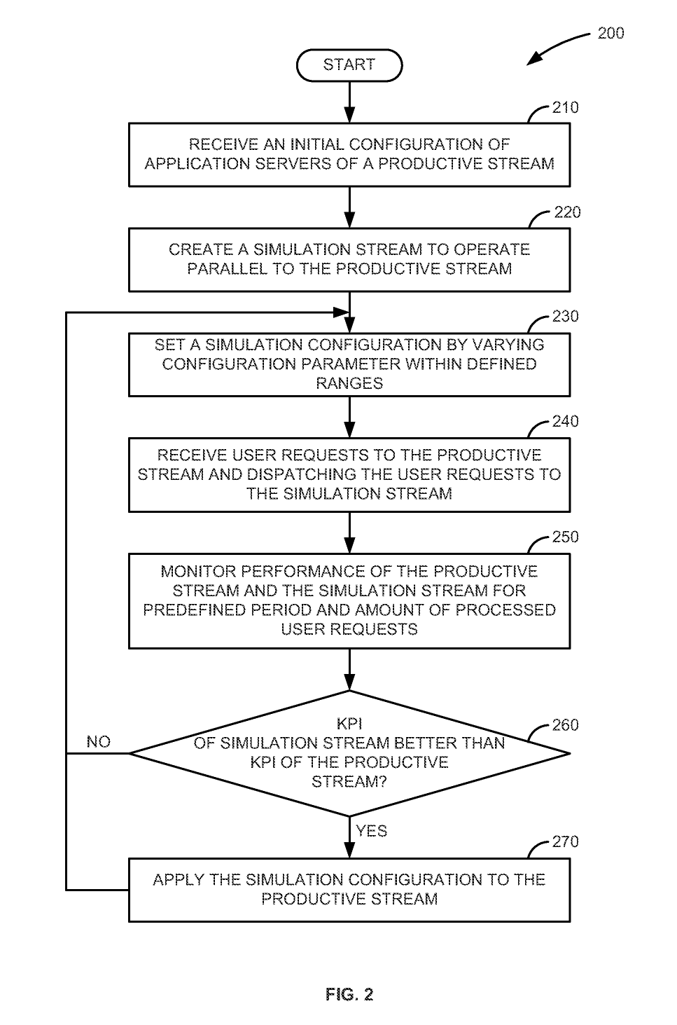

FIG. 2 is a flow diagram of an embodiment of a method 200 of real-time self-optimization of a business software system on multitenant based cloud infrastructure. The method begins at block 210 with receiving an initial configuration of application servers of a productive stream of the business software system. The productive stream of the business software system is the architecture that serves real client requests. The productive stream of the system is running with the optimal technical configuration, which has been found by previous simulations. The system architecture may be such as the three-layer system architecture presented in FIG. 1. In one embodiment, the productive stream operates on a tenant-enabled database, which means several tenants may be served by a single instance of a database manager operating on the tenant-enabled database. In one embodiment, the initial configuration is within a freespace configuration, the freespace configuration defining ranges of configuration parameters based on key performance indicators (KPIs) for the performance of the business software system. The set of parameters for the system configuration is spanning a multidimensional space. The concrete subset of configuration parameter ranges (freespace) is a subspace which can be used by the system for the simulations. In this subspace (freespace) the system can use by random or by a heuristic a concrete configuration vector for each simulation. The KPIs may be such as: “minimize response time”, “minimize number of servers”, “maximize number of requests”, “maximize number of users”, etc. The freespace configuration that defines ranges of configuration parameters may include “number of servers” (e.g. 6 to 10), “number of users” (e.g. up to 1000), “number of requests” (e.g. at least 5000), etc. In one embodiment, the initial configuration is based on configuration best practices and the KPIs of the business software system.

At block 220, a simulation stream is created to operate parallel to the productive stream for configuration optimization purposes. The simulation stream is dedicated to testing purposes simulating the real productive environment. In one embodiment, the simulation stream includes a tenant clone of the tenant-enabled database and a set of application servers reserved for simulation. The tenant clone of the tenant-enabled database is an exact copy of the tenant enabled database and real requests may be redirected to the tenant clone for testing purposes.

At block 230, a simulation configuration is set by varying configuration parameters within defined ranges for the set of application servers reserved for simulation. The ranges of configuration are defined by the freespace configuration, as depicted in connection to block 210.

Further, at block 240, user requests are received to the productive stream and the user requests are dispatched to the simulation stream. The received user requests to the productive stream are requests to tenant-enabled database and processed by the application servers of the productive stream. The dispatched user requests to the simulation stream are requests processed by the application servers reserved for simulation. The application servers reserved for simulation operate on the tenant-clone of the tenant enabled database and hence the user requests may affect the content both of the tenant-enabled database and the tenant clone at the same time. In one embodiment, a predefined percentage of the received user requests are dispatched to the tenant clone of the tenant-enabled database. In one embodiment, a percentage at the range of 5-10 from the total received requests is dispatched to the simulation stream, thus sealing the real requests for testing purposes.

Then, at block 250, the performance of the productive stream and the simulation stream are monitored for a predefined period and amount of processed user requests. In one embodiment, monitoring the performance of the productive stream and the simulation stream includes comparing database images of the tenant-enabled database and the tenant clone of the tenant-enabled database for inconsistencies. Inconsistencies of the compared images determine not equally processed user requests by the productive stream and the simulation stream. This means the simulation stream has not processed the requests the same way as the productive stream, which causes different data in the tenant-enabled database and the tenant clone of the tenant-enabled database. In another embodiment, the simulation stream is aborted, when the compared database images are inconsistent.

At block 260, a comparison is performed, whether the KPIs of the simulation stream are better than the KPIs of the productive stream. For example, if a KPI is “minimum response time” and the response time of the simulation stream is shorter than the response time of the productive stream, this determines that the KPI of the simulation stream is better the one of the current productive stream. Another example is if KPI is “minimum number of servers”, then the KPI of the simulation stream is better than the KPI of the productive stream if the simulation stream performs the same load of user requests with fewer servers than the simulation stream.

If the KPI's of the simulation stream are better than the KPIs of the productive stream, this means the simulation configuration set at block 230 is better than the current configuration of the productive stream and the process continues at block 270 with applying the simulation configuration to the productive stream and then turning back to block 230 for setting another simulation configuration for testing. If the KPI's of the simulation stream are not better than the KPIs of the productive stream, this means the simulation configuration set at block 230 is not better than the current configuration of the productive stream, the process gets back to block 230 setting another simulation configuration by varying configuration parameters within the defined ranges. Then another simulation starts by dispatching real user requests to the newly configured simulation stream running in parallel to the productive stream. In one embodiment, applying the simulation configuration to the productive stream when the KPIs of the simulation stream are better than the KPIs of the productive stream is performed by applying configuration parameters in steps and observing the performance of the business software system. By applying the configuration parameters in steps is aimed to adjust the productive system configuration gradually. Gradual implementation of configuration parameters allows tracking of configuration parameters that may cause undesired performance of the productive stream.

In one embodiment, a backup is created of the configuration of the productive stream. The back-up is used for rollback purposes in case an applied configuration to the productive stream results in the productive stream performing in an undesired way.

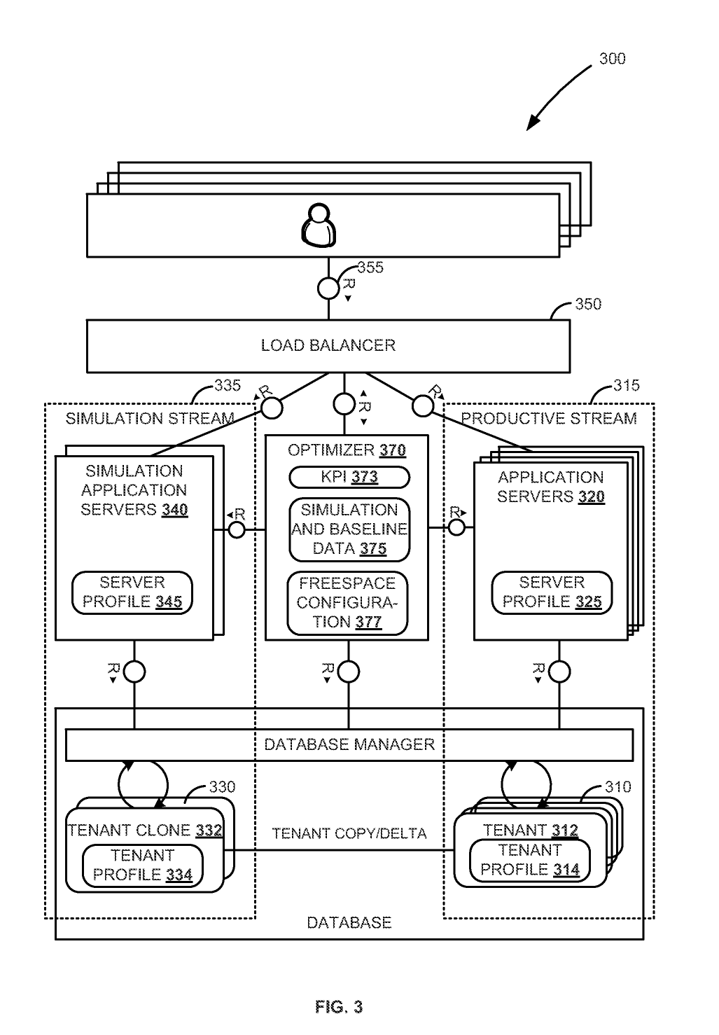

FIG. 3 is a block diagram of an embodiment of a real-time self-optimizing business software system on multitenant based cloud infrastructure. The system 300 includes a tenant enabled database 310 and one or more application servers 320 operating on the tenant-enabled database 310. The tenant-enabled database 310 and the one or more application servers 320 form a productive stream 315. Each application server from application servers 320 has a profile, such as server profile 325 including server specific configuration parameters. The configuration parameters may include number of work processes, size of session roll area, size of program execution area, size of database table caches, etc. Each tenant from the tenant-enabled database 310 has a profile, such as tenant profile 314 for the tenant 312. The tenant profile includes tenant-specific system parameters such as maximum allowed transaction time, maximum allowed request processing time, etc. The system 300 further includes a tenant clone 330 of the tenant-enabled database 310 and a set of simulation application servers 340 reserved for simulations. The tenant clone 330 of the tenant-enabled database 310 and the set of simulation application servers 340 form a simulation stream 335. Each application server from the set of simulation application servers 340 has a profile, such as server profile 345. Each tenant from the tenant clone 330 has a profile, such as tenant profile 334 for the tenant 332.

The system 300 also includes a load balancer 350 to handle client requests 355 from clients 360 to the one or more application servers 320 operating on the tenant-enabled database 310 and to dispatch the received one or more client requests 355 to the tenant clone 330 of the tenant-enabled database 310 through the set of simulation application servers 340. In one embodiment, the load balancer 350 is operable to dispatch a predefined percentage of the client requests 355 to the tenant clone 330 of the tenant-enabled database 310.

The system 300 further includes an optimizer 370. The optimizer 370 is operable to set a simulation configuration by varying configuration parameters within defined ranges of configuration parameters for the set of simulation application servers 340. The defined ranges of configuration parameters are persisted in a freespace configuration 377 within the optimizer 370. The defined ranges are based on key performance indicators (KPI 373) for the performance of the business software system 300. The optimizer 370 is further operable to monitor performance of the tenant-enabled database 310 with the one or more application servers 320 and the tenant clone 330 of the tenant-enabled database 310 with the set of simulation application servers 340 for predefined period and amount of processed client requests 355. For that purpose, the optimizer 370 processes simulation and baseline data 375. The optimizer 370 is further operable to apply the simulation configuration to the productive stream 315 when key performance indicators (KPIs) of the simulation stream 335 are better than KPIs of the productive stream 315. In one embodiment, the optimizer 370 is operable to compare database images of the tenant-enabled database 310 and the tenant clone 330 of the tenant-enabled database 310 for inconsistencies. In another embodiment, the optimizer 370 is operable to abort the simulation stream 335 when the compared database images are inconsistent.

In one embodiment, the optimizer 370 is operable to apply the configuration parameters in steps and observe performance of the business software system when applying the simulation configuration to the productive stream 315. In yet another embodiment, the optimizer 370 is operable to create a back-up of the configuration of the productive stream 315 for rollback purposes.

A real-time self-optimizing system for multitenant based cloud infrastructure such as the system 300 presented in FIG. 3 may be used in the following exemplary situation: there is a system with 10 application servers, 50 tenants, and 50,000 users. The goal is to minimize the number of application servers while preserving a minimum response time of 0.20 seconds. The defined range for application servers is 6 to 10. The simulation shall last 7 days. The simulation configuration is set by varying simulation application servers between 6 and 10 running instances within the seven days and monitoring the corresponding average response time of the user requests. The optimized number of application servers is the result of the best fit number of application servers of the simulation.

Another example of using a real-time self-optimizing system for multitenant based cloud infrastructure such as the system 300: there is a system with 10 application servers, 50 tenants, and 50,000 users. The goal is to minimize the size of the session roll areas (memory). The free-space configuration is set to 4 application server as simulation servers, the maximum number of simulation tenants is 5, the maximum number of simulation users is 1000, and the simulation shall run for 5 working days. The simulation tenants and simulation users will be determined by random. Absolute minimum and absolute maximum for session roll area size is configured. Tenant-copies will be created for each simulation pass. Each pass runs for one working day. The optimizer uses 5 passes to find the best fit session roll area size starting with min size and a step size of (max size−min size)/5. The simulation servers will be configured with this session roll area sizes and the requests of the simulation tenant users will be additionally routed to the simulation servers. The response time will be monitored. The optimized size of the session roll area is the result of the best fit number of the simulations.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Sonic example embodiments may include remote procedure calls being used to implement one or more of these components across a distributed programming environment. For example, a logic level may reside on a first computer system that is remotely located from a second computer system containing an interface level (e. g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java®, C++, or other object-oriented programming language and development tools. Another embodiment may be implemented in hard-wired circuitry in place of, or in combination with machine readable software instructions.

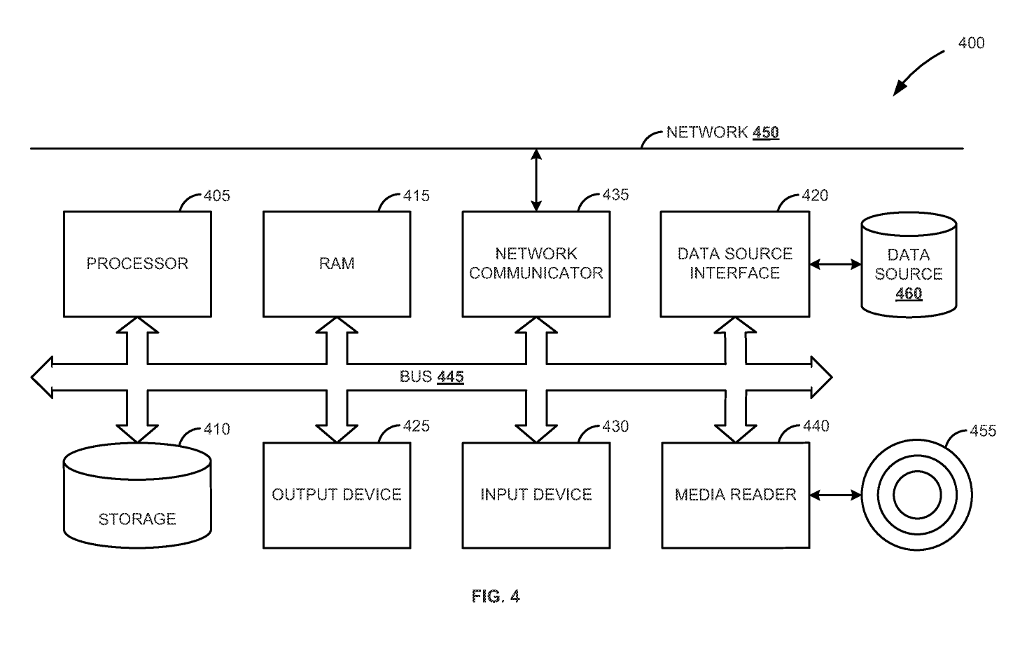

FIG. 4 is a block diagram of an exemplary computer system 400. The computer system 400 includes a processor 405 that executes software instructions or code stored on a computer readable storage medium 455 to perform the above-illustrated methods. The computer system 400 includes a media reader 440 to read the instructions from the computer readable storage medium 455 and store the instructions in storage 410 or in random access memory (RAM) 415. The storage 410 provides a large space for keeping static data where at least some instructions could be stored for later execution. The stored instructions may be further compiled to generate other representations of the instructions and dynamically stored in the RAM 415. The processor 405 reads instructions from the RAM 415 and performs actions as instructed. According to one embodiment, the computer system 400 further includes an output device 425 (e. g., a display) to provide at least some of the results of the execution as output including, but not limited to, visual information to users and an input device 430 to provide a user or another device with means for entering data and/or otherwise interact with the computer system 400. Each of these output devices 425 and input devices 430 could be joined by one or more additional peripherals to further expand the capabilities of the computer system 400. A network communicator 435 may be provided to connect the computer system 400 to a network 450 and in turn to other devices connected to the network 450 including other clients, servers, data stores, and interfaces, for instance. The modules of the computer system 400 are interconnected via a bus 445. Computer system 400 includes a data source interface 420 to access data source 460. The data source 460 can be accessed via one or more abstraction layers implemented in hardware or software. For example, the data source 460 may be accessed by network 450. In some embodiments the data source 460 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e. g., OLAP), object oriented databases, and the like. Further data sources include tabular data (e. g., spreadsheets, delimited text tiles), data tagged with a markup language (e. g., XML data), transactional data, unstructured data (e. g., text files, screen scrapings), hierarchical data (e. g., data in a file system, XML data), files, a plurality of reports, and any other data source accessible through an established protocol, such as, Open DataBase Connectivity (ODBC), produced by an underlying software system (e. g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. in other instances, well-known operations or structures are not shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the present disclosure are described herein for illustrative purposes, various equivalent modifications are possible within the scope of the present disclosure, as those skilled in the relevant art will recognize. These modifications can be made in light of the above detailed description. Rather, the scope is to be determined by the following claims, which are to be interpreted in accordance with established doctrines of claim construction.

What is claimed is:

1. A computer implemented method for real-time self-optimizing business software system on multitenant based cloud infrastructure comprising:
receiving an initial configuration of one or more application servers of a productive stream of the multitenant based cloud infrastructure, the productive stream operating on a tenant-enabled database, and wherein the initial configuration is within a freespace configuration defining ranges of configuration parameters based on key performance indicators (KPIs) for the performance of the business software system;
creating a simulation stream to operate parallel to the productive stream for configuration optimization purposes, the simulation stream comprising a tenant clone of the tenant-enabled database and a set of application servers reserved for simulations;
setting a simulation configuration by varying configuration parameters within the defined ranges of configuration parameters for the set of application servers reserved for simulation;
receiving one or more user requests to the tenant-enabled database through the productive stream, the one or more user requests processed by the one or more application servers of the productive stream;
dispatching the received one or more user requests to the tenant clone of the tenant-enabled database through the simulation stream, the one or more user requests processed by the set of application servers reserved for simulations;
monitoring performance of the productive stream and the simulation stream for a predefined period and amount of processed user requests; and
applying the simulation configuration to the productive stream based on a comparison of KPIs of the simulation stream and KPIs of the productive stream.

2. The method of claim 1, wherein the initial configuration is based on KPIs for the business software system.

3. The method of claim 1, wherein a predefined percentage of the received one or more user requests are dispatched to the tenant clone of the tenant-enabled database.

4. The method of claim 1, wherein monitoring the performance of the productive stream and the simulation stream further comprises comparing database images of the tenant-enabled database and the tenant clone of the tenant-enabled database for inconsistencies.

5. The method of claim 4, further comprising aborting the simulation stream when the compared database images are inconsistent.

6. The method of claim 1, wherein applying the simulation configuration to the productive stream further comprises applying the configuration parameters in steps and observing performance of the business software system.

7. The method of claim 6, further comprising creating a back-up of the configuration of the productive stream for rollback purposes.

8. A computer system for real-time self-optimizing business software system on multitenant based cloud infrastructure comprising:
a tenant-enabled database;
one or more application servers operating on the tenant-enabled database, the tenant enabled database and the one or more application servers forming a productive stream;
a tenant clone of the tenant-enabled database;
a set of simulation application servers reserved for simulations, the simulation application servers operating on the tenant clone of the tenant-enabled database, the tenant clone and the set of simulation application servers forming a simulation stream;
a load balancer to handle client requests to the one or more application servers operating on the tenant-enabled database and to dispatch the client requests to the tenant clone of the tenant-enabled database through the set of simulation application servers; and
an optimizer to:
set a simulation configuration by varying configuration parameters within defined ranges of configuration parameters for the set of simulation application servers;
monitor performance of the tenant-enabled database with the one or more application servers and the tenant clone of the tenant-enabled database with the set of simulation application servers for predefined period and amount of processed client requests; and
apply the simulation configuration to the productive stream based on a comparison of KPIs of the simulation stream and KPIs of the productive stream.

9. The system of claim 8 wherein the load balancer is operable to dispatch a predefined percentage of the received client requests to the tenant clone of the tenant-enabled database.

10. The system of claim 8, wherein the optimizer is further operable to compare database images of the tenant-enabled database and the tenant clone of the tenant-enabled database for inconsistencies.

11. The system of claim 9, wherein the optimizer is further operable to abort the simulation stream when the compared database images are inconsistent.

12. The system of claim 8, wherein the optimizer is further operable to apply the configuration parameters in steps and observe performance of the business software system when applying the simulation configuration to the productive stream.

13. The system of claim 12, wherein the optimizer is further operable to create a back-up of the configuration of the productive stream for rollback purposes.

14. An article of manufacture including a non-transitory computer readable storage medium to tangibly store instructions, which when executed by a computer, cause the computer to:
receive an initial configuration of one or more application servers of a productive stream of a multitenant based cloud infrastructure, the productive stream operating on a tenant-enabled database, and wherein the initial configuration is within a freespace configuration defining ranges of configuration parameters based on key performance indicators (KPIs) for the performance of a business software system;
create a simulation stream to operate parallel to the productive stream for configuration optimization purposes, the simulation stream comprising a tenant clone of the tenant-enabled database and a set of application servers reserved for simulations;
set a simulation configuration by varying configuration parameters within the defined ranges of configuration parameters for the set of application servers reserved for simulation;
receive one or more user requests to the tenant enabled database through the productive stream, the one or more user requests processed by the one or more application servers of the productive stream;
dispatch the received one or more user requests to the tenant clone of the tenant-enabled database through the simulation stream, the one or more user requests processed by the set of application servers reserved for simulations;
monitor performance of the productive stream and the simulation stream for a predefined period and amount of processed user requests; and
apply the simulation configuration to the productive stream based on a comparison of KPIs of the simulation stream and KPIs of the productive stream.

15. The article of manufacture of claim 14, wherein the initial configuration is based on KPIs for the business software system.

16. The article of manufacture of claim 14, wherein a predefined percentage of the received one or more user requests are dispatched to the tenant clone of the tenant-enabled database.

17. The article of manufacture of claim 14, wherein the instructions to monitor the performance of the productive stream and the simulation stream further comprise instructions, which when executed by a computer, cause the computer to compare database images of the tenant-enabled database and the tenant clone of the tenant-enabled database for inconsistencies.

18. The article of manufacture of claim 17, further comprising instructions, which when executed by a computer cause the computer to abort the simulation stream when the compared database images are inconsistent.

19. The article of manufacture of claim 18, wherein the instructions apply the simulation configuration to the productive stream further comprise instructions, which when executed by a computer, cause the computer to apply the configuration parameters in steps and observe performance of the business software system.

20. The article of manufacture of claim 19, further comprising instructions, which when executed by a computer, cause the computer to create a back-up of the configuration of the productive stream for rollback purposes.
